(19) United States
(12) Patent Application Publication
(10) Pub. No.: US 2010/0039468 A1
(43) Pub. Date: Feb. 18, 2010

(54) ADJUSTMENT METHOD

(75) Inventors: Toru MIYAMOTO, Shiojiri (JP); Toru TAKAHASHI, Azumino (JP); Hirokazu KASAHARA, Okaya (JP); Hideaki KASAHARA, Matsumoto (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Tokyo (JP)

(21) Appl. No.: 12/535,257

(22) Filed: Aug. 4, 2009

(30) Foreign Application Priority Data
Aug. 13, 2008 (JP) 2008-208693

(51) Int. Cl. B41J 29/38

(52) U.S. Cl. 347/14

(57) ABSTRACT

A method of adjusting a print apparatus includes: a first nozzle array configured of nozzles which are aligned in a predetermined direction to eject a liquid to a medium; a second nozzle array configured of nozzles which are aligned in the predetermined direction to eject a liquid to a medium; a base plate on which the first nozzle array and the second nozzle array are disposed on positions shifted in a direction cross to the predetermined direction; and a moving mechanism which moves the base plate and a medium relative to each other in a moving direction, wherein a first pattern is formed by the first nozzle array, and a second pattern is formed by the second nozzle array so as to be adjacent to the first pattern in a direction cross to the moving direction, and wherein an inclination of the base plate with respect to the moving direction is adjusted on the basis of an interval between the first pattern and the second pattern in a direction cross to the moving direction.

The entire disclosure of Japanese Patent Application No. 2008-208693, filed Aug. 13, 2008, is expressly incorporated by reference herein.

### BACKGROUND

1. Technical Field

The invention relates to an adjustment method.

2. Related Art

In a printer which includes a large number of nozzles aligned at a predetermined interval along a paper width length of a paper and which relatively moves the paper and the nozzle arrays in a moving direction cross to the paper width direction, high speed printing is possible. However, in this case, it is difficult to align nozzles in a long head in the paper width direction due to a problem in manufacturing. The printer is proposed in which plural short heads include the nozzle arrays in which the nozzles are aligned in a predetermined direction and are mounted on a base plate in a staggered shape (for example, refer to JP-A-2008-18639).

In the above-mentioned printer, when the base plate is mounted on the printer such that the nozzle direction of the heads is obliquely mounted with respect to the direction (paper width direction) cross to the moving direction of the printer, the print image quality is degraded.

### SUMMARY

An advantage of some aspects of the invention is to adjust the inclination of the base plate with respect to the moving direction of the printer.

According to an aspect of the invention, there is provided a method of adjusting a print apparatus which includes: a first nozzle array in which nozzles are aligned in a predetermined direction to eject a liquid to a medium; a second nozzle array in which nozzles are aligned in the predetermined direction to eject a liquid to a medium; a base plate on which the first nozzle array and the second nozzle array are disposed on positions shifted in a direction cross to the predetermined direction; and a moving mechanism which moves the base plate and a medium relative to each other in a moving direction, the method comprising: forming a first pattern by the first nozzle array; forming a second pattern by the second nozzle array so as to be adjacent to the first pattern in a direction cross to the moving direction; and adjusting an inclination of the base plate with respect to the moving direction on the basis of an interval between the first pattern and the second pattern in a direction cross to the moving direction.

Other aspects of the invention will be apparent through the descriptions of this specification and the accompanying drawings.

### BRIEF DESCRIPTION OF THE DRAWINGS

The invention will be described with reference to the accompanying drawings, wherein like numbers reference like elements.

FIG. 1 is a block diagram illustrating an entire configuration of a printer according to an embodiment.

FIG. 2A is a cross-sectional view illustrating a printer.

FIG. 2B is a view illustrating a printer transporting a paper.

FIG. 3A is a view illustrating an arrangement of heads.

FIG. 3B is a view illustrating an arrangement of nozzles.

FIG. 4A is a view illustrating a dot formation when heads are mounted parallel to each other.

FIG. 4B is a view illustrating a dot formation when heads are obliquely mounted.

FIG. 5 is a view illustrating a flow for mounting a base plate to a printer.

FIG. 6A is an overall view illustrating a test pattern.

FIG. 6B is a view illustrating a pattern formed by heads.

FIG. 7A is a view illustrating a test pattern when a nozzle array and a paper width direction are parallel to each other.

FIG. 7B is a view illustrating a test pattern when a nozzle array is obliquely mounted in a counterclockwise direction with respect to the paper width direction.

FIG. 7C is a view illustrating a test pattern when a nozzle array is obliquely mounted in a clockwise direction with respect to the paper width direction.

FIG. 8 is a view illustrating a test pattern when an inclination of a base plate is large.

FIG. 9A is a view illustrating a test pattern of two nozzle arrays of which the interval therebetween is long.

FIG. 9B is a view illustrating a test pattern of two nozzle arrays of which the interval therebetween is short.

FIG. 10 is a view illustrating a test pattern which is formed by a base plate different from that of an embodiment.

FIG. 11 is a view illustrating another pattern for detecting an inclination of a base plate with respect to a transport direction.

FIG. 12 is a view illustrating a pattern formed when a nozzle array is obliquely mounted in a counterclockwise direction with respect to the paper width direction.

FIG. 13A is a view illustrating a resulting test pattern when a downstream head is obliquely mounted on a base plate.

FIG. 13B is a view illustrating a resulting test pattern when a downstream head is obliquely mounted on a base plate.

FIG. 14 is a view illustrating another pattern for detecting an inclination of a base plate with respect to the transport direction.

FIG. 15 is a view illustrating a pattern when a nozzle array is obliquely mounted in a counterclockwise direction with respect to the paper width direction.

FIG. 16A is a view illustrating a resulting test pattern when a downstream head is obliquely mounted on a base plate.

FIG. 16B is a view illustrating a resulting test pattern when a downstream head is obliquely mounted on a base plate.

### DESCRIPTION OF EXEMPLARY EMBODIMENTS

### Outlines of Disclosure

At least the following aspects will be apparent through the descriptions of this specification and the accompanying drawings.

That is, a method of adjusting a print apparatus which includes: a first nozzle array in which nozzles are aligned in a predetermined direction to eject a liquid to a medium; a second nozzle array in which nozzles are aligned in the predetermined direction to eject a liquid to a medium; a base plate on which the first nozzle array and the second nozzle array are disposed on positions shifted in a direction cross to the predetermined direction; and a moving mechanism which moves the base plate and a medium relative to each other in a moving direction, the method comprising: forming a first pattern by the first nozzle array; forming a second pattern by the second nozzle array so as to be adjacent to the first pattern in a direction cross to the moving direction; and adjusting an inclination of the base plate with respect to the moving direction on the basis of an interval between the first pattern and the second pattern in a direction cross to the moving direction.

According to the adjustment method, the nozzle array direction (predetermined direction) of the base plate can be parallel to the direction cross to the moving direction of the print apparatus. As a result, it is possible to suppress the deterioration in image quality.

According to such an adjustment method, the first nozzle array belongs to a first head, the second nozzle array belongs to a second head, the first head and the second head are disposed on the base plate such that the first nozzle array and the second nozzle array are shifted in the predetermined direction.

According to the adjustment method, the nozzle array direction (predetermined direction) of the heads mounted on the base plate can be parallel to the direction cross to the moving direction of the print apparatus. As a result, it is possible to suppress the deterioration in image quality.

According to such an adjustment method, an inclination direction of the base plate with respect to the moving direction is detected on the basis of an interval between the first pattern and the second pattern in a direction cross to the moving direction.

According to the adjustment method, the nozzle array direction (predetermined direction) of the heads mounted on the base plate can be parallel to the direction cross to the moving direction of the print apparatus. As a result, it is possible to suppress the deterioration in image quality.

According to such an adjustment method, an inclination amount of the base plate with respect to the moving direction is detected on the basis of an interval between the first pattern and the second pattern in a direction cross to the moving direction.

According to the adjustment method, the nozzle array direction (predetermined direction) of the heads mounted on the base plate can be parallel to the direction cross to the moving direction of the print apparatus. As a result, it is possible to suppress the deterioration in image quality.

According to such an adjustment method, the first nozzle array is positioned to one side in the predetermined direction from the second nozzle array, the first pattern and the second pattern are each configured such that a plurality of dot arrays disposed in the moving direction are aligned in a direction cross to the moving direction, and a length of the dot array formed by the nozzle positioned on the end of the other side in the predetermined direction among the nozzles of the first nozzle array forming the first pattern is different from lengths of the dot arrays formed by other nozzles.

According to the adjustment method, the interval between the first pattern and the second pattern in the direction cross to the moving direction can be detected with high accuracy.

According to such an adjustment method, in which the print apparatus includes a third head having a third nozzle array in which nozzles are aligned in the predetermined direction to eject a liquid to a medium, and is configured such that the first nozzle array and the third nozzle array are aligned in the predetermined direction and the first nozzle array, the second nozzle array, and the third nozzle array are shifted in the predetermined direction in order from one side in the predetermined direction so that the third head is mounted on the base plate, the method further includes: forming a third pattern so as to be adjacent to the second pattern in a direction cross to the moving direction by the third nozzle array at the same time as forming the first pattern and the second pattern; and adjusting an inclination of the base plate with respect to the moving direction by comparing an interval between the first pattern and the second pattern in a direction cross to the moving direction and the interval between the second pattern and the third pattern in a direction cross to the moving direction.

According to the adjustment method, the inclination of the base plate with respect to the moving direction can be detected with high accuracy.

According to such an adjustment method, the first head includes a fourth nozzle array which includes nozzles aligned in the predetermined direction to eject a liquid to a medium, and is aligned in a direction cross to the predetermined direction with respect to the first nozzle array, the method further includes: forming a plurality of dot arrays disposed along the moving direction of the first pattern in a direction cross to the moving direction at a predetermined interval by the nozzles of the first nozzle array; forming a plurality of dot arrays disposed along the moving direction in a direction cross to the moving direction at a predetermined interval by the nozzles of the fourth nozzle array; and adjusting an inclination of the first head with respect to the moving direction on the basis of a positional relationship in a direction cross to the moving direction between the dot arrays formed by the first nozzle array and the dot arrays formed by the fourth nozzle array.

According to the adjustment method, the nozzle array direction (predetermined direction) of the head can be parallel to the direction cross to the moving direction of the print apparatus. As a result, it is possible to suppress the deterioration in image quality.

### Line Head Printer

Hereinafter, it is assumed that a liquid ejecting apparatus is an ink jet printer, and a line head printer (printer 1) among the ink jet printer will be described as an example.

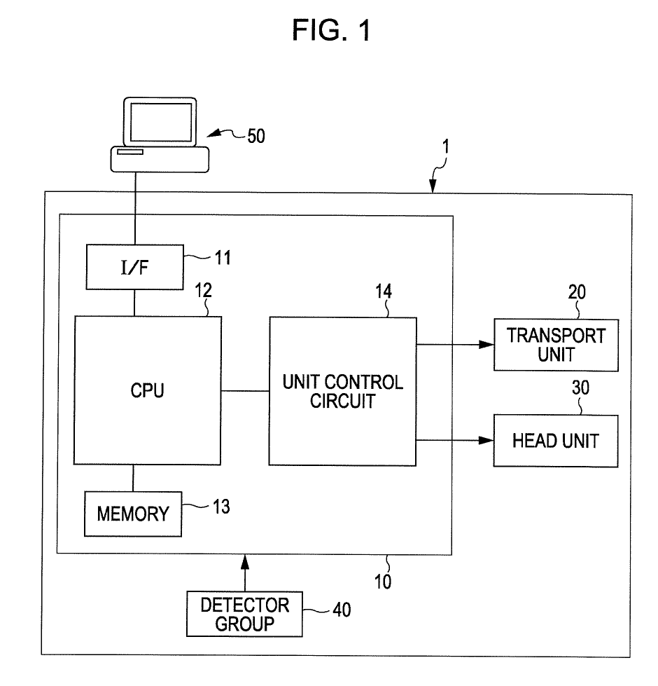

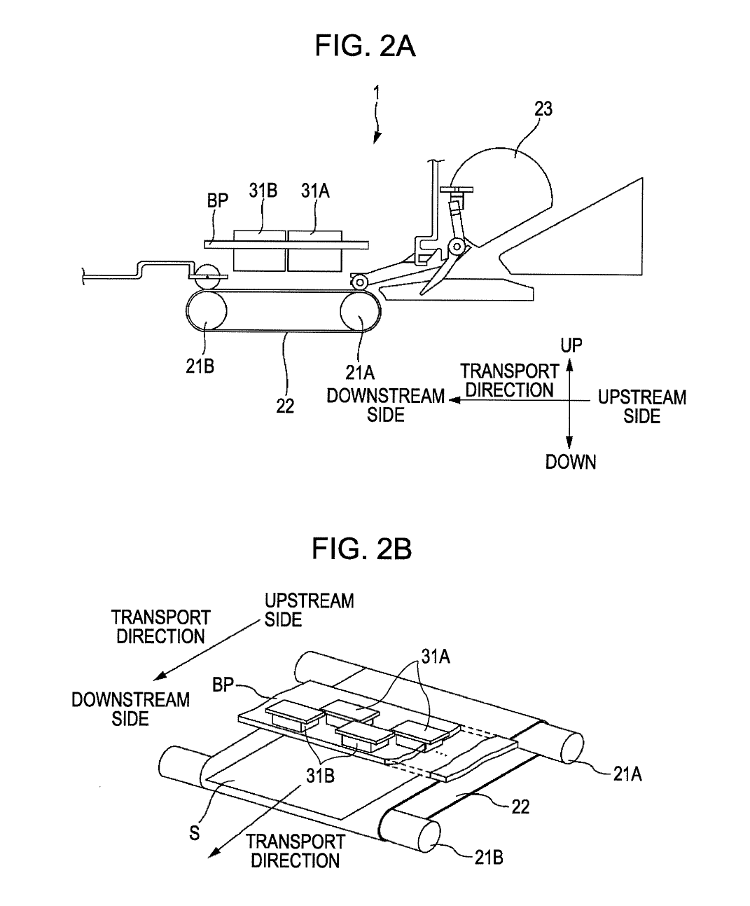

FIG. 1 is a block diagram illustrating an entire configuration of the printer 1 according to this embodiment. FIG. 2A is a sectional view illustrating the printer 1. FIG. 2B is a view illustrating the printer 1 transporting a paper S (medium). The printer 1 receives print data from a computer 50 as an external apparatus, and controls units (transport unit 20, head unit 30) by a controller 10 to form an image on the paper S. In addition, a detector group 40 monitors circumstances in the printer 1, and the controller 10 controls the respective units on the basis of the detection results.

The controller 10 is a control unit for performing control on the printer 1. An interface unit 11 serves to transmit and receive data between the computer 50 as the external apparatus and the printer 1. A CPU 12 is an arithmetic processing unit for performing control on the entire printer 1. A memory 13 serves to secure areas for storing programs executed by the CPU 12 or working areas. The CPU 12 controls the respective units by a unit controlling circuit 14 according to the programs stored in the memory 13.

The transport unit 20 (moving mechanism) includes transport rollers 21A and 21B and a transport belt 22. The transport unit 20 feeds the paper S to a printable position. In printing, the transport unit 20 transports the paper S inserted into the paper insertion port in a transport direction at a predetermined transport speed. A feed roller 23 is a roller for automatically feeding the paper S onto the transport belt 22 in the printer 1. As the annular transport belt 22 is rotated by the transport rollers 21A and 21B, the paper S is transported onto the transport belt 22. In addition, the transport belt 22 vacuum-adsorbs the paper thereon to prevent the paper from a positional misalignment.

The head unit 30 serves to eject the ink onto the paper S, and includes plural heads 31 and base plate BP. On the bottom surface of the head 31, plural nozzles are provided to serve as an ink ejecting portion. In connection with each nozzle, there are provided a pressure chamber (not shown) filled with the ink and a driving element (piezoelectric element) for changing capacity in the pressure chamber to eject the ink. When a driving signal is applied to the driving element, the driving element is deformed. Then, according to the deformation, the pressure chamber expands and shrinks to eject the ink.

In such a line head printer, when the controller 10 receives the print data, the controller 10 first rotates the feed roller 23 to transport the printing paper S onto the transport belt 22. The paper S is transported on the transport belt 22 at a constant speed without stopping, and then passes through under the head unit 30. During the paper S passes through under the head unit 30, the respective nozzles intermittently eject the ink. As a result, the dot arrays made of plural dots disposed along the transport direction are formed on the paper S, and thus the image is printed.

### Arrangement of Head 31

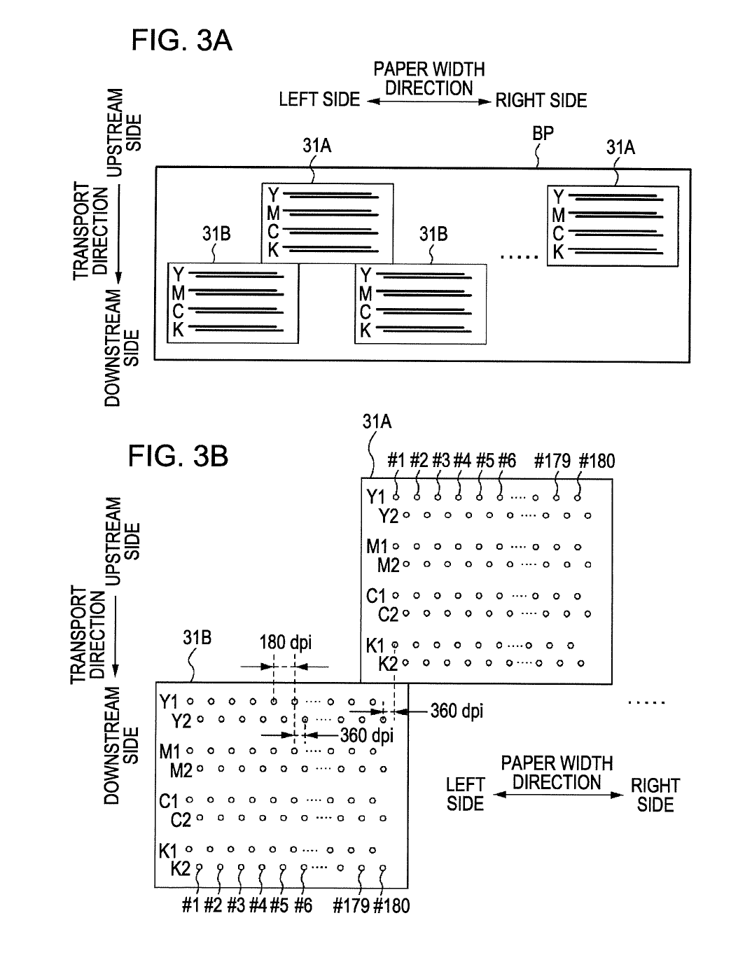

FIG. 3A is a view illustrating an arrangement of heads 31 which are mounted on a base plate BP. FIG. 3B is a view illustrating an arrangement of the nozzles disposed on the lower surface of the heads 31. On the base plate BP, openings are provided such that a nozzle surface of the head 31 is exposed to a paper S (or a transport belt 22). As shown in the drawing, plural heads 31 included in the printer 1 are mounted on the base plate BP in a staggered shape. For convenience of explanation, the head 31 disposed on an upstream side of the transport direction (which corresponds to the moving direction) is called “an upstream head 31A”, and the head 31 disposed on a downstream side of the transport direction is called “a downstream head 31B”. The nozzle arrays of the upstream head 31A and the nozzle arrays of the downstream head 31B are separated in the direction cross to a nozzle array direction (predetermined direction). In addition, the nozzle arrays of the upstream head 31A and the nozzle arrays of the downstream head 31B are shifted in the nozzle array direction. Then, an “upstream head group”, which is configured of the upstream heads 31A disposed in the paper width direction at a predetermined interval, is positioned on the upstream side of the transport direction from a “downstream head group” which is configured of the downstream heads 31B disposed in the paper width direction at a predetermined interval.

The respective heads 31A and 31B have two nozzles per one color. On the lower surface of the head 31, two yellow nozzle arrays Y1 and Y2, two magenta nozzle arrays M1 and M2, two cyan nozzle arrays C1 and C2, and two black nozzle arrays K1 and K2 are formed. Each nozzle array is provided with 180 nozzles (nozzles #1 to #180). The nozzles are arranged in the paper width direction at a predetermined interval (180 dpi). Then, two nozzle arrays (for example, Y1 and Y2) for ejecting the same color ink are disposed on positions shifted from each other in the paper width direction at an interval of 360 dpi. That is, in one head 31, the nozzles for ejecting four colors of ink are aligned in the paper width direction at an interval of 360 dpi, respectively.

In addition, as shown in FIG. 3B, in the upstream head 31A and the downstream head 31B, which are aligned in the paper width direction, the interval between the rightmost nozzle #180 in the left downstream head 31B and the leftmost nozzle #1 in the right upstream head 31A is set to 360 dpi. In this way, the upstream head 31A and the downstream head 31B are disposed in a staggered shape such that the interval between the nozzles (#1 and #180) disposed on both ends of the nozzle array of the upstream head 31A and the nozzles (#1 and #180) disposed on both ends of the nozzle array of the downstream head 31B in the paper width direction is set to be 360 dpi.

To sum up, on the lower surface of the base plate BP, the nozzles for ejecting the four colors of ink Y, M, C, and K are aligned in the paper width direction at the interval of 360 dpi (nozzle pitch), respectively. The length obtained by summing the nozzle arrays of the respective heads 31 becomes the maximum print range of the printer 1 in the paper width direction. In addition, in FIG. 3B, the nozzle arrays of the heads 31 adjacent to each other in the paper width direction are not overlapped with each other, but the invention is not limited thereto. The nozzle arrays disposed on both ends of the heads 31 adjacent to each other may be formed to be overlapped with each other.

### Inclination of Base Plate BP

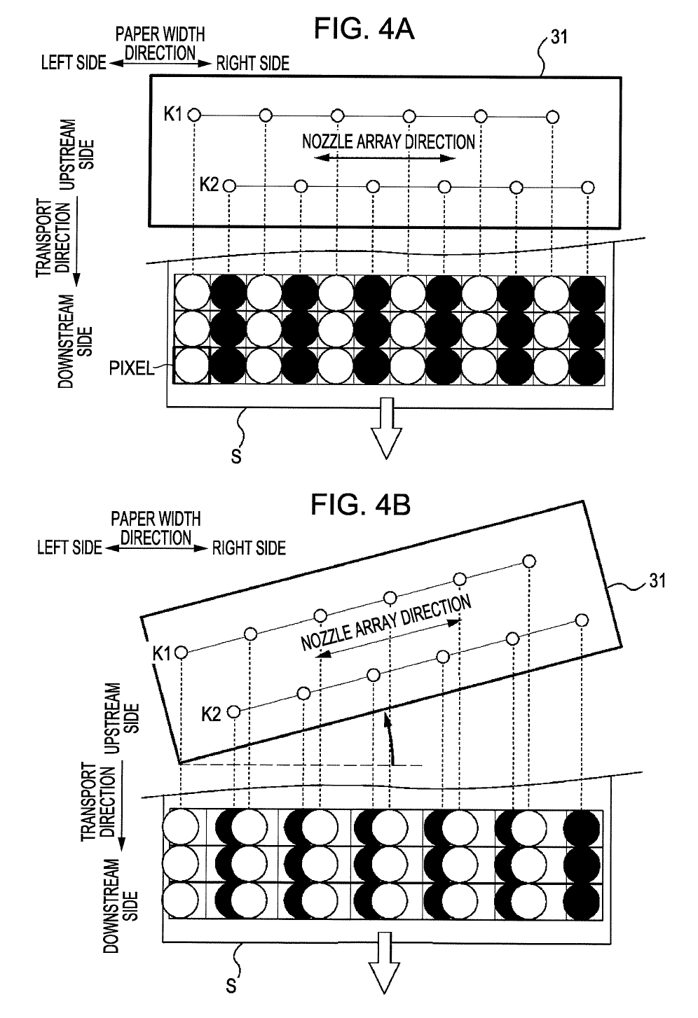

FIG. 4A is a view illustrating a dot formation when the nozzle array direction and the paper width direction of the head 31 which are mounted on the base plate BP are parallel to each other. FIG. 4B is a view illustrating the dot formation when the nozzle array direction of the head 31 which is mounted on the base plate BP is inclined with respect to the paper width direction. For convenience of explanation in the drawing, one head 31 among plural heads 31 which are mounted on the base plate BP are shown, and the nozzles arrays and the nozzles are illustrated by reducing the numbers thereof, respectively. The nozzle array provided on the lower surface of the head 31 is configured such that the plural nozzles are aligned in a predetermined direction (hereinafter, referred to as a nozzle array direction). Then, the head 31 is mounted such that the nozzle array direction is parallel to the paper width direction cross to the transport direction which is defined on the basis of a transport unit 20 of the printer 1.

In addition, on the paper S, a virtual “pixel” is given in order to define positions of the dots to be recorded. A print image is configured such that the pixels are two-dimensionally aligned in parallel to the side directions (vertical direction and horizontal direction) of the paper S. The paper S is transported such that the vertical side of the paper S is parallel to the transport direction in the printer 1. That is, on the paper S, the pixels are aligned in the transport direction and the paper width direction cross to the transport direction. In the drawing, the pixels are aligned in the paper width direction with the nozzle pitch interval (360 dpi) therebetween, and the paper S is transported such that the pixels aligned in the paper width direction face the nozzles.

As shown in FIG. 4A, when the nozzle arrays are disposed along the paper width direction, the dot arrays aligned in the paper width direction with the interval of 360 dpi therebetween are formed by two black nozzle arrays K1 and K2. That is, when the head 31 (nozzle array) is mounted in parallel to the paper width direction, the dots (◯) formed by the upstream black nozzle array K1 in the transport direction and the dots () formed by the downstream black nozzle array K2 in the transport direction are aligned at equal intervals (360 dpi) in the paper width direction.

As shown in FIG. 4B, when the head 31 (nozzle array) is obliquely mounted with respect to the paper width direction, the dots are formed on positions shifted from the pixels defined on the paper S. In addition, since two black nozzle arrays K1 and K2 are disposed separate in a direction cross to the nozzle array direction, misalignment amounts of the dot forming positions are different from each other. In FIG. 4B, the dots (◯) formed by the upstream black nozzle array K1 in the transport direction and the dots () formed by the downstream black nozzle array K2 in the transport direction are formed to be overlapped with each other. That is, when the head 31 (nozzle array) is obliquely mounted with respect to the paper width direction, the intervals between the dots aligned in the paper width direction do not become constant.

In this way, when the base plate BP is mounted on the printer 1 such that the nozzle array direction of the heads 31 mounted on the base plate BP is inclined with respect to the paper width direction, the dots are not formed on the positions (pixels) indicated by the print data. In addition, the interval between the dots aligned in the paper width direction is not constant. As a result, the print image quality is degraded. An object of this embodiment is to mount the base plate BP on the printer 1 such that the nozzle array direction of the heads 31 mounted on the base plate BP is parallel to the paper width direction cross to the transport direction of the printer 1. That is, by adjusting the inclination of the base plate BP with respect to the transport direction (moving direction) of the printer 1, it is possible to suppress the deterioration in image quality of the print image.

### Inclination Adjustment of Base Plate BP

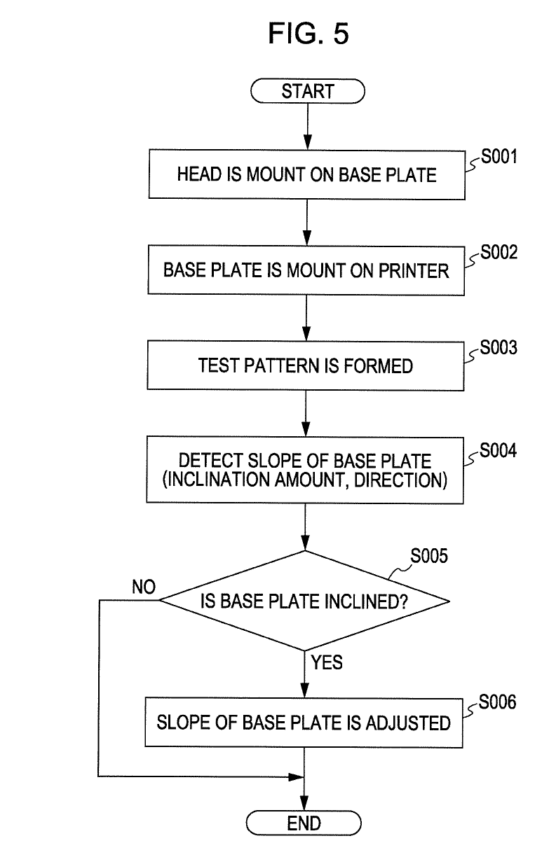

FIG. 5 is a view illustrating a flow for mounting the base plate BP on the printer 1 in the manufacturing process of the printer 1. First, as shown in FIG. 3A, plural heads 31A and 31B are mounted on the base plate BP such that the respective nozzle arrays of the upstream head 31A and the downstream head 31B are disposed along a predetermined direction (S001). At this time, the respective heads 31A and 31B are mounted on the base plate BP such that the interval between the nozzles disposed on the ends of the upstream head 31A and the downstream head 31B is 360 dpi. Thereafter, the base plate BP on which the heads 31 are mounted is mounted on the printer 1 (S002).

In this embodiment, in order to confirm that the base plate BP is correctly mounted on the printer 1, a test pattern is actually printed by the printer 1 (S003). On the basis of the resulting test pattern, the inclination of the base plate BP with respect to the transport direction of the printer 1 is adjusted.

### TEST PATTERN: FIRST EXAMPLE

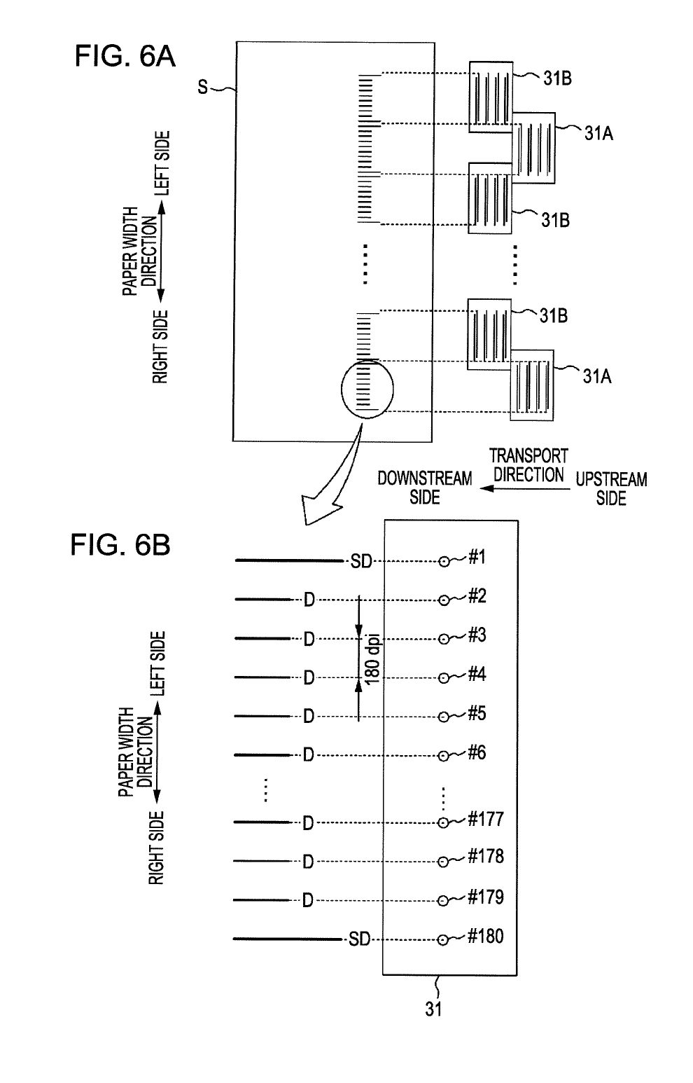

FIG. 6A is an overall view illustrating the test pattern printed on the paper S. FIG. 6B is a view illustrating a pattern P1 (which corresponds to a first pattern and a second pattern) formed by each head 31. The heads 31 are aligned in the paper width direction in a staggered shape, and every head 31 forms one pattern P1. For this reason, plural patterns P1 are disposed on the paper S in the paper width direction. That is, the pattern P1 formed by the nozzle array (which corresponds to the first nozzle array) of the upstream head 31A and the pattern P1 formed by the nozzle array (which corresponds to the second nozzle array) of the downstream head 31B are formed so as to be adjacent to each other in the paper width direction. In addition, the pattern P1 is formed using one nozzle array (for example, black nozzle array K) among the eight nozzle arrays included in one head 31.

The pattern P1 is configured of the dot arrays D which are disposed along the transport direction. In FIG. 6B, since all of the nozzles (#1 to #180) belonging to the nozzle arrays forming the pattern P1 form the dot arrays D, the dot arrays D are aligned in the paper width direction at an interval of 180 dpi. In this case, the dot arrays formed by the nozzles (#1 and #180) disposed on the ends of the nozzle array are called “reference dot arrays SD”. The length of the reference dot arrays SD is longer than that of the dot arrays D formed by other nozzles #2 to #179.

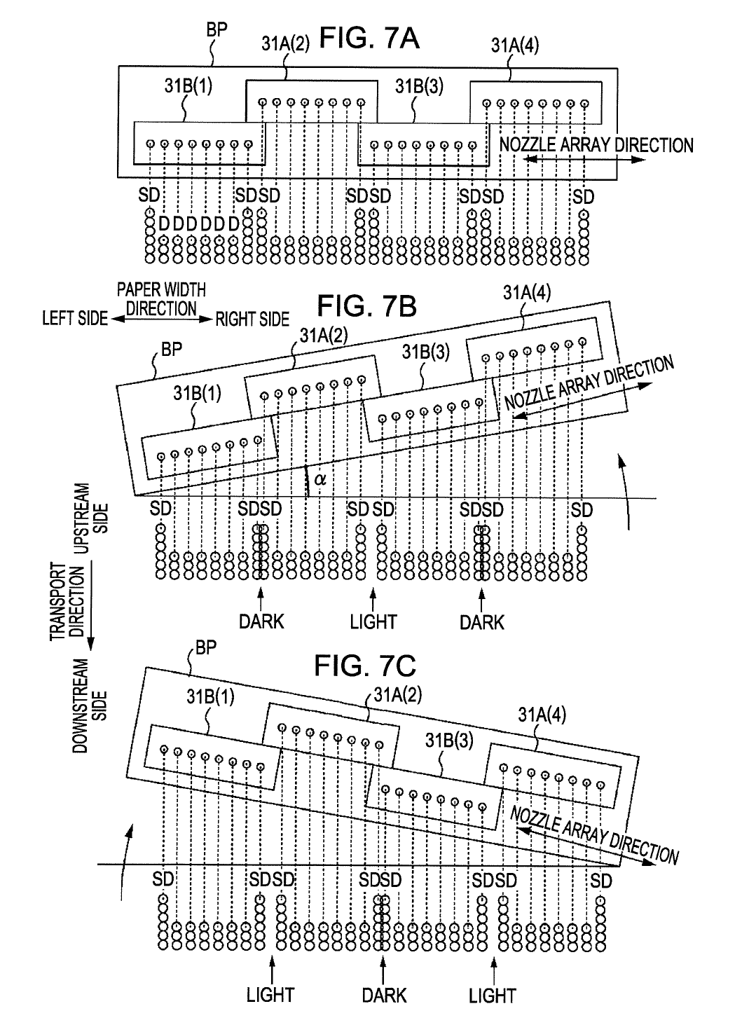

FIG. 7A is a view illustrating the test pattern when the base plate BP is mounted on the correct position of the printer 1 and the nozzle array direction is parallel to the paper width direction. FIG. 7B is a view illustrating the test pattern when the nozzle array direction is inclined in the counterclockwise direction with respect to the paper width direction. FIG. 7C is a view illustrating the test pattern when the nozzle array direction is inclined in the clockwise direction with respect to the paper width direction. Further, in the drawings, the heads and the nozzles are illustrated by reducing the numbers thereof, and the dots of the dot array are illustrated as “◯”.

As shown in FIG. 7A, when the base plate BP is mounted on the correct position without inclination with respect to the transport direction, the interval between the dot arrays constituting the test pattern in the paper width direction is equal to the nozzle pitch (180 dpi) of the nozzle array. The interval between the reference dot arrays SD, which are formed in a joint portion (nozzles disposed on the ends) between the upstream head 31A and the downstream head 31B, in the paper width direction is also 180 dpi, and all of the dot arrays are aligned in the paper width direction at equal intervals.

On the other hand, as shown in FIG. 7B, when the nozzle array direction is inclined in the counterclockwise direction with respect to the paper width direction, the interval between the reference dot arrays SD which are formed on the joint portion between the upstream head 31A and the downstream head 31B becomes narrower or wider. The interval between the reference dot array SD formed by the nozzle disposed on the right end of the leftmost downstream head 31B(1) and the reference dot array SD formed by the nozzle disposed on the left end of the upstream head 31A(2) becomes narrower than the nozzle pitch, and the dot arrays SD are formed to be overlapped with each other. On the contrary, the interval between the reference dot array SD formed by the nozzle disposed on the right end of the upstream head 31A(2) and the reference dot array SD formed by the nozzle disposed on the left end of the downstream head 31B(3) becomes wider than the nozzle pitch. For this reason, when the test pattern formed by the upstream heads 31A and the downstream heads 31B is viewed as a whole, a region which is darkly identified because the reference dot arrays SD are overlapped and a region which is lightly identified because the reference dot arrays SD are formed separately by the nozzle pitch are alternately formed.

On the other hand, as shown in FIG. 7C, when the nozzle array direction is inclined in the clockwise direction with respect to the paper width direction, the interval between the reference dot array SD formed by the nozzle disposed on the right end of the leftmost downstream head 31B(1) and the reference dot array SD formed by the nozzle disposed on the left end of the upstream head 31A(2) becomes wider than the nozzle pitch and is lightly identified. On the contrary, the interval between the reference dot array SD formed by the nozzle disposed on the right end of the upstream head 31A(2) and the reference dot array SD formed by the nozzle disposed on the left end of the downstream head 31B(3) becomes narrower than the nozzle pitch and is darkly identified. Also in FIG. 7C, when the test pattern is viewed as a whole, the light-colored region and the dark-colored region are alternately formed, but they are inversely displayed compared with that shown in FIG. 7B.

That is, in the base plate BP on which the heads 31 are mounted in a staggered shape in the order of the downstream head 31B, the upstream head 31A, . . . from the left side in the paper width direction, when the nozzle arrays are inclined in the “counterclockwise direction” with respect to the paper width direction (see FIG. 7B), the test pattern is formed in the order of “dark-colored region, light-colored region, dark-colored region, . . . ” from the left side in the paper width direction. When the nozzle arrays are inclined in the “clockwise direction” with respect to the paper width direction (see FIG. 7C), the test pattern is formed in the order of “light-colored region, dark-colored region, light-colored region, . . . ” from the left side in the paper width direction. In other words, the inclination direction of the base plate BP is detected with respect to the moving direction on the basis of the interval between the reference dot array SD (pattern P1) formed by the downstream head 31B and the reference dot array SD (pattern P1) formed by the upstream head 31A in the paper width direction.

In addition, comparing the interval (the left interval) between the reference dot array SD formed by the downstream head 31B(1) (which corresponds to the first head) disposed on the left end in the paper width direction and the reference dot array SD formed by the upstream head 31A(2) (which corresponds to the second head) adjacent to the right side thereof with the interval (the right interval) between the reference dot array SD formed by the upstream head 31A(2) and the reference dot array SD formed by the downstream head 31B(2) (which corresponds to the third head) adjacent to the right thereof, when the left interval is narrower than the right interval (if darkly identified) as shown in FIG. 7B, it is possible to determine that the base plate BP is inclined in the counterclockwise direction.

Therefore, first, by confirming whether or not there is a dark-colored region or a light-colored region compared with the other regions in the resulting test pattern in this embodiment, it is possible to confirm whether or not the base plate BP is obliquely mounted with respect to the transport direction and whether the nozzle array is inclined in the paper width direction.

A difference in contrasting density appears in the test pattern by the interval in the paper width direction between the reference dot arrays SD which are formed on the joint portion between the upstream head 31A and the downstream head 31B. For this reason, as shown in FIG. 6, there is a need to pay attention to the dot arrays which are formed on the joint portion between the heads 31 among a number of dot arrays D aligned in the paper width direction. Here, in order to reliably locate the reference dot arrays SD formed on the joint portion between the heads 31 among a number of dot arrays D formed in the test pattern, it is preferable that the length of the reference dot arrays SD formed on the joint portion between the heads 31 (by the nozzles #1 and #180 disposed on the end of the nozzle array) is set differently from the length of the dot arrays formed by other nozzles #2 to #179. Further, in this embodiment, the reference dot arrays SD are longer than other dot arrays D, but the invention is not limited thereto. The reference dot arrays SD may be shorter than other dot arrays D. In addition, the length of the reference dot arrays SD and the length of other dot arrays D may be the same.

When the dark-colored region or the light-colored region appears in the resulting test pattern, it is possible to detect whether or not the nozzle array direction is inclined in the counterclockwise direction or in the clockwise direction with respect to the paper width direction according to the order in which the dark-colored regions and the light-colored regions are aligned. For example, when the dark-colored regions and the light-colored regions are aligned in the order of “dark-colored region, light-colored region, dark-colored region, . . . ” from the left side in the paper width direction in the test pattern result, it is possible to determine that the base plate BP is mounted such that the nozzle array direction is inclined in the counterclockwise direction as shown in FIG. 7B.

Since the upstream heads 31A and the downstream heads 31B are disposed on positions shifted from each other in the transport direction, the amount of misalignment between the dot forming positions is different in the upstream heads 31A and the downstream heads 31B when the base plate BP is not inclined and when the base plate BP is inclined. As a result, the interval in the paper width direction between the reference dot arrays SD formed on the joint portion between the upstream head 31A and the downstream head 31B becomes narrower and wider than the interval in the paper width direction between other dot arrays D. In this embodiment, using this result, it is determined whether or not the nozzle array direction is inclined with respect to the paper width direction. Because of the inclined direction of the nozzle array direction, the interval between the reference dot arrays SD in the paper width direction changes even on the same joint portion between the upstream head 31A and the downstream head 31B. Using this result, the inclined direction of the nozzle array direction with respect to the paper width direction is detected.

That is, the dot arrays are alternately formed in the paper width direction using the nozzles belonging to the nozzle arrays which are disposed separate from each other in the transport direction and shifted in the paper width direction, so that it is possible to detect the inclination and the inclined direction of the nozzle arrays (the base plate) with respect to the paper width direction.

In addition, in FIG. 6, the test pattern is formed using all of the heads 31 included in the printer 1 and the inclination of the base plate BP with respect to the transport direction is detected, but the invention is not limited thereto. When the pattern P1 is formed by two heads of the upstream head 31A and the downstream head 31B which are aligned in a staggered shape in the paper width direction, it is possible to detect the inclination and the inclined direction of the base plate BP. For example, the pattern P1 is formed by the downstream head 31B(1) positioned on the left side in the paper width direction shown in FIG. 7B and the upstream head 31A(2) positioned on the right side. Then, when the interval between the reference dot arrays SD formed on the joint portion between two heads 31B(1) and 31A(2) becomes narrow and darkly identified as shown in FIG. 7B, it is possible to determine that the base plate BP is inclined in the counterclockwise direction. On the contrary, when the interval between the reference dot arrays SD formed on the joint portion between two heads 31B(1) and 31A(2) becomes wide and lightly identified as shown in FIG. 7C, it is possible to determine that the base plate BP is inclined in the clockwise direction. In this case, as shown in FIG. 7B, plural intervals between the reference dot arrays SD formed by the upstream heads 31A and the reference dot arrays SD formed by the downstream heads 31B are compared. Then, the inclination of the base plate BP with respect to the moving direction is detected on the basis of the comparison. Therefore, it is possible to detect the inclination of the base plate BP with high accuracy regardless of the difference in characteristics between the heads 31.

In this embodiment described above, the inclination of the base plate BP is detected on the basis of the interval (concentration density) in the paper width direction between the reference dot arrays SD which are formed on the joint portion between two heads 31 aligned in a staggered shape. In addition, the papers (medium) for forming the test pattern thereon have a different degree of ink absorption. For example, when the test pattern is formed on a plain paper which soaks up the ink easily and the dot arrays D are formed by all of the nozzles as the pattern P1 shown in FIG. 6B, the interval between the dot arrays D becomes narrow (180 dpi). For this reason, there is some danger that it may be impossible to determine whether the base plate BP is inclined so that the reference dot arrays SD are overlapped with each other and darkly identified or whether the ink has been soaked up so that the dot arrays SD are overlapped with each other and darkly identified. When the pattern is formed, the pattern may be formed using the nozzles disposed on every second nozzle or on every Nth nozzle (N is an integer of 2 or more) without using all of the nozzles belonging to the nozzle arrays. In this way, the inclination of the base plate BP can be detected regardless of the kind of the paper upon which the test pattern is formed.

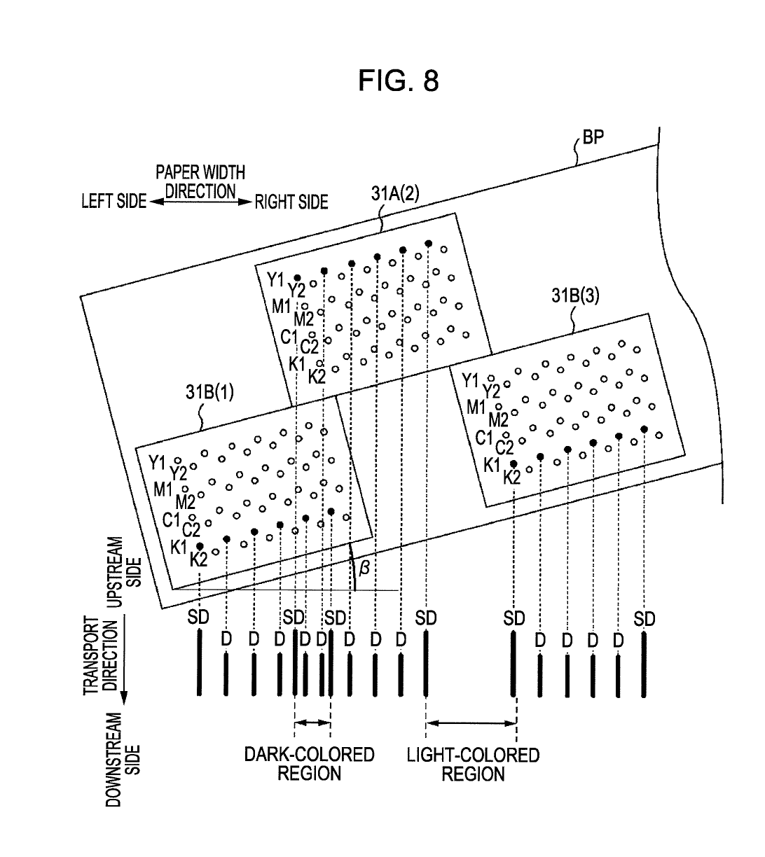

FIG. 8 is a view illustrating the test pattern formed in a case where the inclination of the base plate BP is large. Also in FIG. 8 similar to FIG. 7B, the head 31 (nozzle array) is inclined in the counterclockwise direction with respect to the paper width direction. In this case, the inclination (angle β) of the base plate BP shown in FIG. 8 is larger than the inclination (angle α) of the base plate shown in FIG. 7B. When the inclination of the base plate BP is excessively large, the reference dot array SD disposed on the left side of the upstream head 31A(2) is formed on a position further shifted on the left side of the reference dot array SD disposed on the right side of the downstream head 31B(1), as shown in FIG. 8. As a result, since the dot arrays SD and D formed by the downstream head 31B(1) and the dot arrays SD and D formed by the upstream head 31A(2) are intermixed with each other, the dark-colored region becomes wider.

On the other hand, the interval between the reference dot array SD disposed on the right side of the upstream head 31A(2) and the reference dot array SD disposed on the left side of the downstream head 31B(3) becomes large, and the light-colored region becomes wide. That is, as the inclination of the base plate BP becomes larger, the regions which are darkly identified or the regions which are lightly identified become larger than the other regions. For this reason, the inclination amount of the base plate BP can be detected on the basis of the size of the dark-colored regions or the light-colored regions. In other words, the inclination amount of the base plate with respect to the moving direction is detected on the basis of the interval between the reference dot array SD (pattern P1) formed by the downstream head 31B and the reference dot array SD (pattern P1) formed by the upstream head 31A.

In this way, the inclination of the base plate BP is detected on the basis of the resulting test pattern. Then, as shown in FIG. 5, when the base plate BP is mounted on the printer 1 such that the nozzles of the head 31 are inclined with respect to the paper width direction (YES in S005), the inclination of the base plate BP is adjusted. By this, the nozzle array direction of the head 31 mounted on the base plate BP is parallel to the paper width direction, so that it is possible to suppress the deterioration in image quality. In addition, it may be confirmed whether or not the base plate BP is mounted such that the nozzle array direction is parallel to the paper width direction after adjusting the inclination of the base plate BP and forming the test pattern again. In addition, the invention is not limited to adjusting the inclination of the base plate BP, but the inclination of the transport unit 20 may be adjusted with respect to the base plate BP.

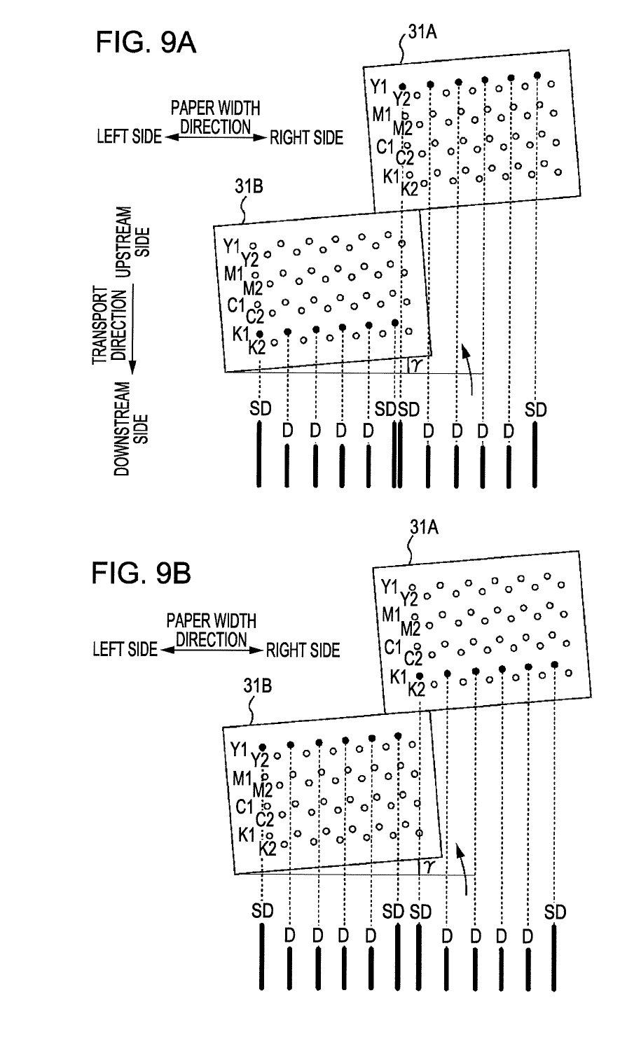

FIG. 9A is a view illustrating the test pattern formed by two nozzle arrays with a long interval therebetween in a direction cross to the nozzle array direction. FIG. 9B is a view illustrating the test pattern formed by two nozzle arrays with a short interval therebetween in a direction cross to the nozzle array direction. In FIG. 9A, the test pattern is formed using the black nozzle array K1 which is positioned relatively on the downstream side in the transport direction among the nozzle arrays included in the downstream head 31B and the yellow nozzle array Y1 which is positioned relatively on the upstream side in the transport direction among the nozzle arrays included in the upstream head 31A. On the other hand, in FIG. 9B, the test pattern is formed using the yellow nozzle array Y1 which is positioned relatively on the upstream side in the transport direction among the nozzle arrays included in the downstream head 31B and the black nozzle array K1 which is positioned relatively on the downstream side in the transport direction among the nozzle arrays included in the upstream head 31A. In FIGS. 9A and 9B, the slopes (angle γ) of the base plates BP (not shown) are the same, and the heads 31A and 31B are inclined in the counterclockwise direction. However, the interval between the reference dot array SD formed by the downstream head 31B and the reference dot array SD formed by the upstream head 31A shown in FIG. 9A becomes narrower than the case shown in FIG. 9B.

In this embodiment, in the nozzle arrays which are disposed separately in the transport direction (a direction cross to the nozzle array direction), the amount of misalignment between the dot forming positions is different when the base plate BP is inclined and when the base plate BP is not inclined, so that the inclination of the base plate BP is detected using the difference in the misalignment amount. For this reason, when the nozzle arrays are selected to form the test pattern by the use of the upstream head 31A and the downstream head 31B, two nozzle arrays may be selected which are too separated in the direction cross to the nozzle array direction, as shown in FIG. 9A. Therefore, since the interval between the reference dot arrays SD becomes narrow or wide even in the case of a small inclination of the base plate BP, the inclination of the base plate BP is easily detected. That is, in the downstream head 31B, the pattern P1 is formed by the nozzle array (for example, the black nozzle array K1) which is positioned on the further downstream side. In the upstream head 31A, the pattern P1 is formed by the nozzle array (for example, the yellow nozzle array Y1) which is positioned on the further upstream side. Accordingly, the inclination of the base plate BP can be detected with high accuracy.

In addition, the invention is not limited so that the pattern P1 must be formed by the black nozzle array K1 disposed on the downstream head 31B and the yellow nozzle array Y1 disposed on the upstream head 31A. In this case, it may be difficult to identify the dot array formed by the yellow nozzle array Y. Therefore, in the upstream head 31A, the test pattern may be formed by the magenta nozzle array M1 which is positioned next to the yellow nozzle array Y1 and on the upstream side in the transport direction (a direction cross to the nozzle array direction).

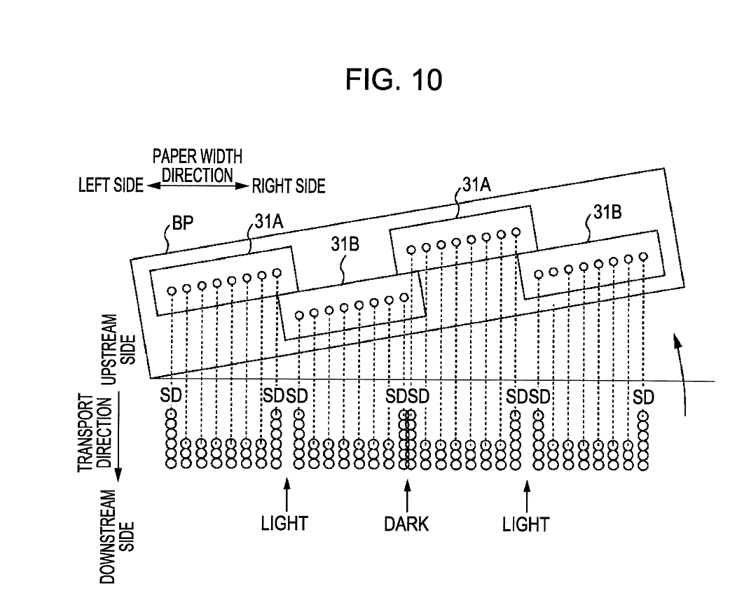

FIG. 10 is a view illustrating an appearance of the test pattern formed by the base plate BP′ of which the arrangement is different from that of the head 31 disposed on the base plate BP according to this embodiment. As shown in FIG. 3A, in the base plate BP according to this embodiment, the heads 31 are disposed in the order of the downstream head 31B, the upstream head 31A, . . . from the left side in the paper width direction. On the other hand, in the base plate BP′ shown in FIG. 10, the heads 31 are disposed in the order of the upstream head 31A, the downstream head 31B, . . . from the left side in the paper width direction. For this reason, when the base plate BP according to this embodiment is also inclined in the counterclockwise direction (see FIG. 7B), the difference in contrasting density appears in the resulting test pattern in the order of “light-colored region, dark-colored region, light-colored region, . . . ” from the left side in the paper width direction. For this, when the base plate BP′ shown in FIG. 10 is similarly inclined in the counterclockwise direction, the difference in contrasting density appears in the resulting test pattern in the order of “light-colored region, dark-colored region, light-colored region, . . . ” from the left side in the paper width direction. In this way, the order of the dark-colored region and the light-colored region appearing in the resulting test pattern is inverted according to the arrangement of the heads 31 disposed on the head plate BP. That is, since the difference in contrasting density appearing in the resulting test pattern is inverted according to the arrangement of the heads 31 mounted on the base plate BP, there is a need to pay attention to the resulting test pattern.

### TEST PATTERN: SECOND EXAMPLE

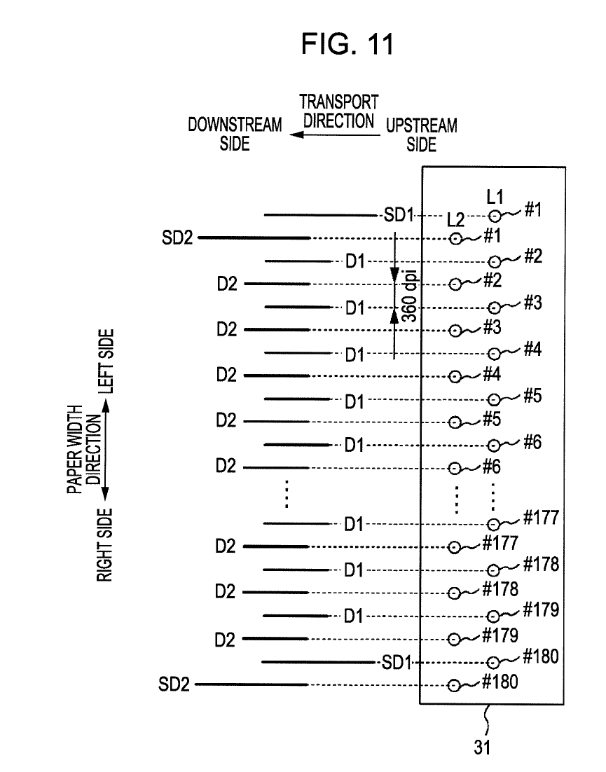

FIG. 11 is a view illustrating another pattern P2 for detecting the inclination of the base plate BP with respect to the transport direction. The pattern P2 in the second example is formed by two nozzle arrays (the first nozzle array L1 and the second nozzle array L2) among eight nozzle arrays included in one head 31. As the first nozzle array L1 (which corresponds to the first nozzle array) and the second nozzle array L2 (which corresponds to the fourth nozzle array), the nozzle arrays disposed on positions shifted in the paper width direction are selected. For example, the pattern P2 can be formed by selecting the yellow nozzle array Y1 disposed on the downstream head 31B shown in FIG. 3B as the first nozzle array L1, and by selecting the black nozzle array K2 disposed on the downstream head 31B as the second nozzle array L2.

The pattern P2 is configured of the dot arrays aligned along the transport direction (the moving direction). Here, the dot arrays formed by the nozzles disposed on the first nozzle array L1 are called “first dot arrays D1”. The first dot arrays D1 are formed at an interval of 180 dpi. On the other hand, the dot arrays formed by the nozzles disposed on the second nozzle array L2 are called “second dot arrays D2”. The second dot arrays D2 are also formed at an interval of 180 dpi. The pattern P2 is formed by all of the nozzles (#1 to #180) belonging to the first nozzle array L1 and all of the nozzles (#1 to #180) belonging to the second nozzle array L2. For this reason, the first dot arrays D1 and the second dot arrays D2 are alternately aligned at an interval of 360 dpi in the paper width direction. In other words, the second dot arrays D2 are formed in the center portion between the first dot arrays D1 aligned in the paper width direction.

A downstream portion of the first dot arrays D1 in the transport direction and an upstream portion of the second dot arrays D2 in the transport direction are formed to be overlapped with each other. The first dot arrays D1 and the second dot arrays D2 have the same length, but the first dot arrays D1 are formed on the upstream side from the second dot arrays D2 in the transport direction. On the contrary, the second dot arrays D2 are formed on the downstream side from the first dot arrays D1 in the transport direction. In this way, the first dot arrays D1 and the second dot arrays D2 are formed on positions shifted in the transport direction. Therefore, when the dot arrays constituting the pattern P2 are viewed, it is possible to determine whether the dot arrays are the dot arrays D1 formed by the first nozzle array L1 or the dot arrays D2 formed by the second nozzle array L2.

In addition, the reference dot arrays SD (a reference first dot array SD1) formed by the nozzles #1 and #180 disposed on the ends of the first nozzle array L1 are formed to be longer than the dot arrays D1 formed by other nozzles #2 to #179 to the upstream side in the transport direction. Similarly, the reference dot arrays (a reference second dot array SD2) formed by the nozzles #1 and #180 (a specific second nozzle) disposed on the ends of the second nozzle array L2 are formed to be longer than the dot arrays D2 formed by the other nozzles #2 to #179 to the downstream side in the transport direction.

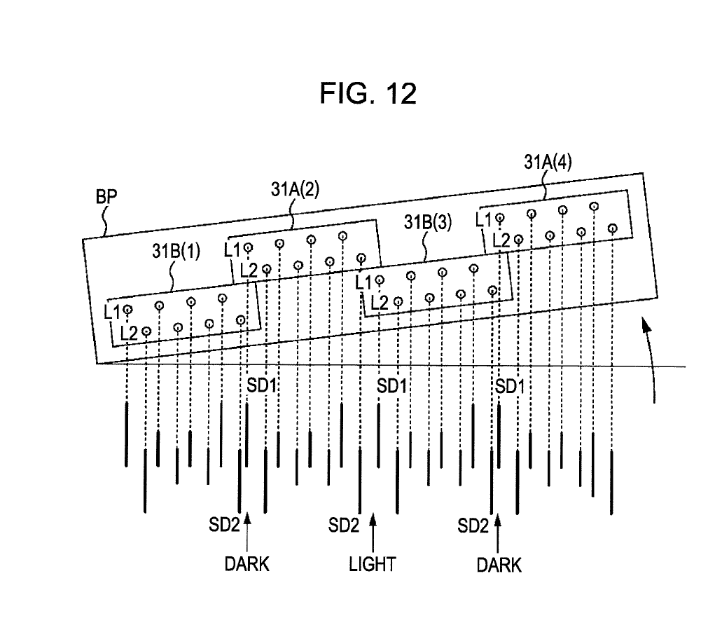

FIG. 12 is a view illustrating the pattern P2 formed in the case where the nozzle arrays are inclined in the counterclockwise direction with respect to the paper width direction. The interval between the reference second dot array SD2 formed by the nozzle disposed on the right end of the downstream head 31B(1) which is positioned on the left side in the paper width direction and the reference first dot arrays SD1 formed by the nozzle disposed on the left end of the upstream head 31A(2) which is positioned on the right side becomes narrower than the nozzle pitch and darkly identified. The interval between the reference second dot array SD2 formed by the nozzle disposed on the right end of the upstream head 31A(2) and the reference first dot array SD1 formed by the nozzle disposed on the left end of the downstream head 31B(3) becomes wider than the nozzle pitch and lightly identified.

Also in the pattern P2 in the second example similarly to the pattern P1 described above (see FIG. 7B), when the base plate BP is mounted such that the nozzle array direction is inclined in the counterclockwise direction with respect to the paper width direction, the difference in contrasting density appears in the resulting test pattern in the order of “dark-colored region, light-colored region, dark-colored region, . . . ” from the left side in the paper width direction. On the contrary, when the base plate BP is mounted such that the nozzle array direction is inclined in the clockwise direction with respect to the paper width direction (not shown), the difference in contrasting density appears in the resulting test pattern in the order of “light-colored region, dark-colored region, light-colored region, . . . ” from the left side in the paper width direction. That is, the inclination and the inclination direction of the base plate BP with respect to the transport direction can also be detected in the resulting test pattern P2 in the second example on the basis of the interval between the reference dot arrays SD1 and SD2 which are formed on the joint portion between the upstream head 31A and the downstream head 31B.

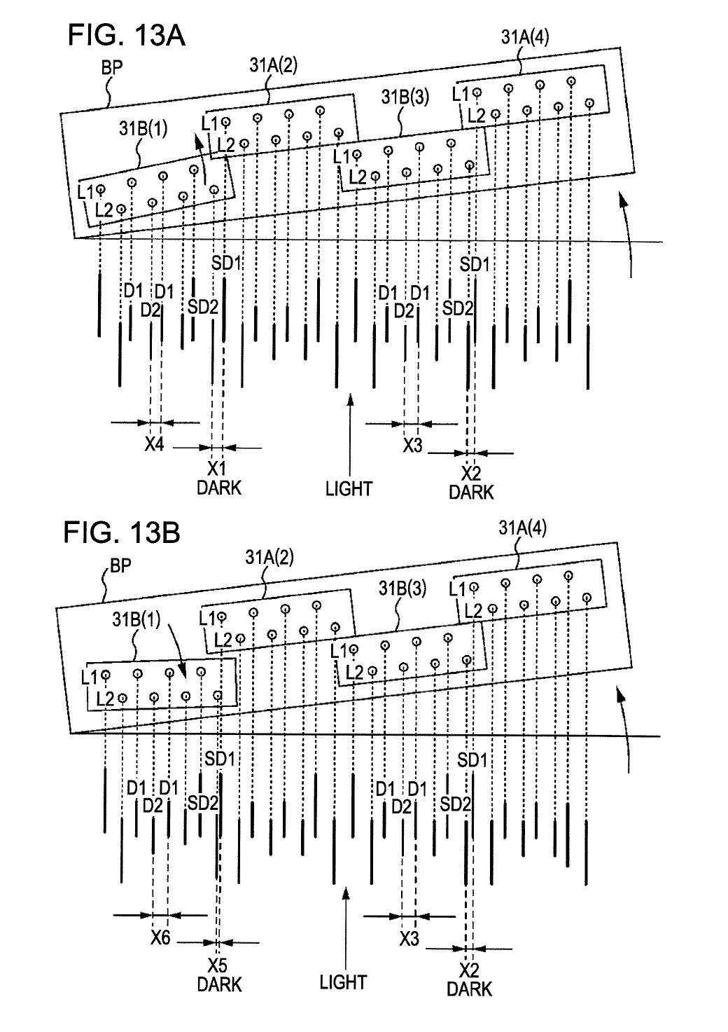

FIGS. 13A and 13B are views illustrating the resulting test pattern in the case where the downstream head 31B(1) is obliquely mounted on the base plate BP. In this embodiment, before the base plate BP is mounted on the printer 1, the inclination of the heads 31 (nozzle arrays) with respect to a predetermined direction (nozzle array direction) or the interval between the heads 31 in a predetermined direction is adjusted, and thus the head 31 is mounted on the base plate BP. At this time, as shown in the drawings, even when the downstream head 31B(1) is obliquely mounted in error, the inclination thereof can be detected according to the pattern P2 in the second example. That is, in addition to the inclination of the base plate BP, the inclination of each head 31 can be detected.

When the base plate BP is inclined in the counterclockwise direction with respect to the paper width direction, as shown in FIG. 12, the difference in contrasting density appears in the resulting test pattern in the order of “dark-colored region, light-colored region, dark-colored region” from the left side in the paper width direction. As shown in FIG. 13A, it is assumed that the downstream head 31B(1) is inclined in the counterclockwise direction compared with other heads 31. At this time, the interval “X1” between the reference dot arrays SD2 and SD1 formed on the joint portion between the inclined downstream head 31B(1) and the upstream head 31A(2) becomes wider than the interval “X2” between the reference dot arrays SD2 and SD1 formed on the joint portion between the downstream head 31B(3) and the upstream head 31A(4) (X1>X2). That is, the base plate BP is inclined to cause the “dark-colored regions” to appear, but the dark-colored region formed on the joint portion of the downstream head 31B(1) which is further inclined in the counterclockwise direction is lightly identified compared with other dark-colored regions.

In addition, the pattern P2 in the second example is formed by two nozzles L1 and L2 which are separated in the transport direction. For this reason, in the first dot arrays D1 formed by the first nozzle array L1 and the second dot arrays D2 formed by the second nozzle array L2, the amount of misalignment between the dot forming positions is different when the heads 31 are inclined and when the heads 31 are not inclined. That is, when the heads 31 are not inclined, the second dot array D2 is formed on the center portion between two first dot arrays D1 which are aligned in the paper width direction, as shown in FIG. 11. When the heads 31 are inclined, the second dot array D2 is formed on a position shifted from the center portion between two first dot arrays D1 which are aligned in the paper width direction. That is, when the slopes of the heads 31 are different, the forming position of the second dot array D2, which is formed between two first dot arrays D1, is changed in the paper width direction.

For this reason, the inclination of each head 31 (the downstream head 31B(1)) mounted on the base plate BP can be detected on the basis of the positional relationship between the first dot arrays D1 and the second dot arrays D2 which are formed by the nozzles except the nozzles disposed on the ends of the head 31. As shown in FIG. 13A, the interval “X3” between the second dot array D2 formed by the downstream head 31B(3) which is correctly mounted on the base plate BP and the first dot array D1 disposed on the right side of the second dot array D2 becomes wider than the interval “X4” between the second dot array D2 formed by the downstream head 31B(1) which is obliquely mounted and the first dot array D1 disposed on the right side of the second dot array D2 (X4>X3). Accordingly, it is possible to determined that the downstream head 31B(1) is obliquely mounted on the base plate BP in the counterclockwise direction.

On the contrary, as shown in FIG. 13B, it is assumed that the downstream head 31B(1) is inclined in the clockwise direction compared with other heads 31. At this time, the interval “X5” between the reference dot arrays SD2 and SD1 which are formed on the joint portion between the downstream head 31B(1) and the upstream head 31A(2) becomes narrower than the interval “X2” between the reference dot arrays SD2 and SD1 which are formed on the joint portion between the downstream head 31B(3) and the upstream head 31A(4) (X5<X2). That is, even though the base plate BP is inclined so as to cause the same “dark-colored region” to appear, the dark-colored region formed on the joint portion of the downstream head 31B(1) which is inclined in the clockwise direction is more darkly identified compared with other dark-colored regions.

In addition, the interval “X2” between the second dot array D2 formed by the downstream head 31B(3) which is correctly mounted and the first dot array D1 disposed on the right side thereof becomes narrower than the interval “X6” between the second dot array D2 formed by the downstream head 31B(1) which is obliquely mounted and the second dot array D2 disposed on the right side thereof (X2<X6). Therefore, it can be seen that the downstream head 31B(1) is obliquely mounted on the base plate BP in the clockwise direction.

To sum up, in the “dark-colored region” or the “light-colored region” which appears in the resulting test pattern, when the pattern portion appearing on the joint portion of a head 31 is further darkly identified or further lightly identified compared with the pattern portion formed on the joint portions of other heads 31, it is possible to determine that the head 31 is mounted on the base plate BP in a tilted state compared with other heads 31. This is not limited to the pattern P2 in the second example, but the pattern P1 in the first example (see FIG. 7) is also the same.

Further, in the pattern P2 in the second example, it is possible to determine that the head 31 is mounted on the base plate BP in a tilted state compared with the other heads 31 on the basis of the interval between the first dot array D1 and the second dot array D2 which are formed by the nozzles belonging to the same head 31.

When there is a head 31 (which is the downstream head 31B(1) in the drawing) which is obliquely mounted on the base plate BP, the inclination of the head 31 may be adjusted in addition to the inclination of the base plate BP. In this way, since the nozzle arrays of the entire heads 31 which are mounted on the base plate BP are parallel to the paper width direction, it is possible to further suppress the deterioration in image quality of the print image.

In addition, in FIG. 13, the case where the downstream head 31B(1) disposed on the left end of the base plate BP is inclined will be described as an example. In this case, only the “dark-colored region” formed on the joint portion between the downstream head 31B(1) and the upstream head 31A(2) disposed on the right side thereof has a concentration different from that of the other dark-colored regions. When the upstream head 31A(2) is inclined, two regions of the “dark-colored region” which is formed on the joint portion between the downstream head 31B(1) and the upstream head 31A(2) and of the “light-colored region” which is formed on the joint portion between the upstream head 31A(2) and the downstream head 31B(3) have a concentration different from that of the other dark-colored regions and light-colored regions.

That is, when the “dark-colored region” which is formed on the joint portion between the downstream head 31B(1) and the upstream head 31A(2) disposed on the right side thereof has a concentration different from that of other dark-colored regions, it is possible to determine which one of the downstream head 31B(1) and the upstream head 31A(2) is obliquely mounted on the base plate BP according to whether or not the “light-colored region” which is formed on the joint portion between the upstream head 31A(2) and the downstream head 31B(3) disposed on the right side thereof has a concentration different from that of other light-colored regions.

### TEST PATTERN: THIRD EXAMPLE

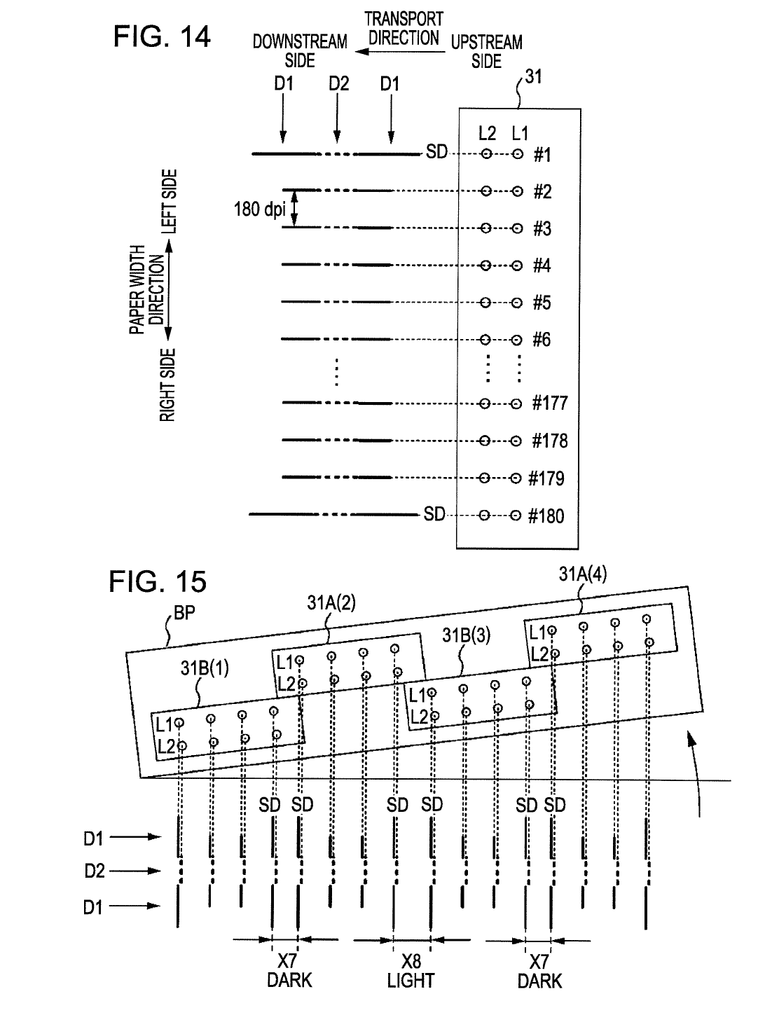

FIG. 14 is a view illustrating another pattern P3 for detecting the inclination of the base plate BP with respect to the transport direction. The pattern P3 in a third example is formed by two nozzle arrays (the first nozzle array L1 and the second nozzle array L2) which have the same nozzle position in the paper width direction among the eight nozzle arrays included in one head 31. For example, the pattern P3 can be formed by selecting the yellow nozzle array Y1 shown in FIG. 3B as the first nozzle array L1 and by selecting the black nozzle array K1 as the second nozzle array L2.

In the pattern P3, the second dot arrays D2 which are formed by the nozzles disposed on the second nozzle array L2 are positioned between the first dot arrays D1 which are formed by the nozzles disposed on the first nozzle array L1. For convenience of explanation, the first dot arrays D1 formed by the first nozzle array L1 are marked with a solid line, and the second dot arrays D2 formed by the second nozzle array L2 are marked with a dotted line. Further, the interval between the dot arrays D1 and D2 which are aligned in the paper width direction is set to “180 dpi”. Then, the reference dot array SD formed by the nozzle disposed on the end portion of the first nozzle array L1 is longer than the first dot arrays D1 formed by other nozzles.

FIG. 15 is a view illustrating the pattern P3 in a case where the nozzle array is inclined in the counterclockwise direction with respect to the paper width direction. The interval “X7” between the reference dot array SD formed by the nozzle disposed on the right end of the downstream head 31B(1) which is positioned on the left side in the paper width direction and the reference dot array SD formed by the nozzle disposed on the left end of the upstream head 31A(2) which is positioned on the right side thereof is narrower than “180 dpi” and is darkly identified. On the other hand, the interval “X8” between the reference dot array SD formed by the nozzle disposed on the right end of the upstream head 31A(2) and the reference dot array SD formed by the nozzle disposed on the left end of the downstream head 31B(3) which is positioned on the right side thereof is wider than “180 dpi” and is lightly identified.

That is, when the base plate BP is mounted on the printer 1 such that the nozzle array of the head 31 is inclined in the counterclockwise direction with respect to the paper width direction, the difference in contrasting density appears in the resulting test pattern in the order of “dark-colored region, light-colored region, dark-colored region, . . . ” from the left side in the paper width direction. On the contrary, when the base plate BP is mounted on the printer 1 such that the nozzle array of the head 31 is inclined in the clockwise direction with respect to the paper width direction (not shown), the difference in contrasting density appears in the resulting test pattern in the order of “light-colored region, dark-colored region, light-colored region, . . . ” from the left side in the paper width direction. In this way, the inclination of the base plate BP with respect to the transport direction can be detected on the basis of the resulting pattern P3 in the third example.

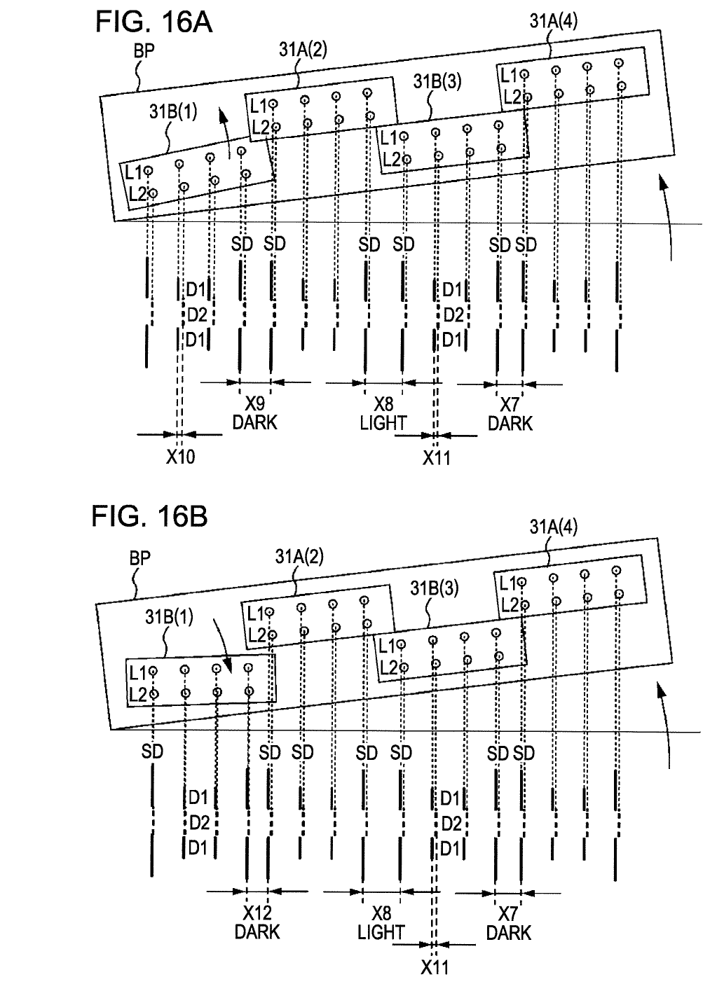

FIGS. 16A and 16B are views illustrating the resulting test patterns in a case where the downstream head 31B(1) is obliquely mounted on the base plate BP. From the pattern P3 in the third example, the inclination of each head 31 can be detected in addition to the inclination of the base plate BP.

It is assumed that the base plate BP is inclined in the counterclockwise direction with respect to the paper width direction and the downstream head 31B(1) is inclined in the counterclockwise direction compared with other heads 31 (see FIG. 16A). The interval “X9” between the reference dot arrays SD which are formed on the joint portion between the obliquely mounted downstream head 31B(1) and the upstream head 31A(2) disposed on the right side thereof becomes wider than the interval “X7” between the reference dot arrays which are formed on the joint portion between the correctly mounted downstream head 31B(3) and the upstream head 31A(4) disposed on the right side thereof (X9>X7).

In addition, the pattern P3 in the third example is formed by two nozzle arrays L1 and L2 which belong to one head 31 and are mounted separately from each other in the transport direction. For this reason, in the first dot array D1 formed by the first nozzle array L1 and the second dot array D2 formed by the second nozzle array L2, the amount of misalignment between the dot forming positions is different when the head 31 is inclined and when the head 31 is not inclined. That is, when the head 31 is not inclined, the first dot array D1 and the second dot array D2 are formed on a straight line in the transport direction, as shown in FIG. 14. However, when the head 31 is inclined, the first dot array D1 and the second dot array D2 are formed on positions shifted in the transport direction. That is, when the slopes of the heads 31 are different from each other, the first dot array D1 and the second dot array D2 are differently shifted in the paper width direction.

For this reason, the inclination of each head 31 can be detected on the basis of the positional relationship between the first dot array D1 and the second dot array D2. In FIG. 16A, the interval “X10” between the first dot array D1 and the second dot array D2 which are formed by the obliquely mounted downstream head 31B(1) is wider than the interval “X11” between the first dot array D1 and the second dot array D2 which are formed by the correctly mounted downstream head 31B(3) (X10>X11). Accordingly, it can be seen that the downstream head 31B(1) is obliquely mounted on the base plate BP in the counterclockwise direction.

On the contrary, it is assumed that the downstream head 31B(1) is inclined in the clockwise direction compared with other heads 31 (see FIG. 16B). At this time, the interval “X12” between the reference dot arrays SD which are formed on the joint portion between the obliquely mounted downstream head 31B(1) and the upstream head 31A(2) disposed on the right side thereof is narrower than the interval “X7” between the reference dot arrays which are formed on the joint portion between the correctly mounted downstream head 31B(3) and the upstream head 31A(4) disposed on the right side thereof (X12<X7). In addition, the first dot array D1 and the second dot array D2 which are formed by the correctly mounted downstream head 31B(3) are formed on positions shifted in the paper width direction. On the other hand, the first dot array D1 and the second dot array D2 which are formed by the obliquely mounted downstream head 31B(1) are aligned on a substantially straight line. Accordingly, it can also be seen that the downstream head 31B(1) is obliquely mounted on the base plate BP in the clockwise direction.

In this way, since the inclination of each head 31 can be detected in addition to the inclination of the base plate BP on the basis of the resulting pattern P3 in the third example, it is possible to make the nozzle arrays disposed on the entire heads 31 mounted on the base plate BP be parallel to the paper width direction. As a result, it is possible to further suppress the deterioration in image quality of the print image.

### Other Embodiments

In the above-mentioned embodiments, the print system having the ink jet printer has been described mainly. However, the disclosures of the adjustment method of the slope of the head and the like are included. In addition, the above-mentioned embodiments are described for the purpose of easily understanding the invention, and nothing described above should be interpreted as limiting the scope of the invention. The invention can be made various changes and improvements without departing the main points. It is matter of course that the invention includes the equivalences. In particular, even the embodiments described below are included in the invention.

### Head 31

In the embodiment described above, the heads 31 are aligned in the staggered shape in the paper width direction, but the invention is not limited thereto. For example, even when one long head disposed in the paper width direction is used which includes plural nozzle arrays Y, M, C, and K aligned in the transport direction and is mounted on the base plate BP, the inclination and the inclined direction of the nozzle array (base plate) can be detected by the test pattern shown in FIG. 6. For example, the test pattern is formed by the right half of the yellow nozzle arrays Y (which corresponds to the head 31A(2) shown in FIG. 7B) in the paper width direction and the left half of the black nozzle arrays K (which corresponds to the head 31B(1) shown in FIG. 7B) in the paper width direction. In this case, the inclination and the inclined direction of the base plate attached to the head can be detected on the basis of the interval between the dot arrays, which are formed on a boundary portion between the yellow nozzle array Y and the black nozzle array K, in the paper width direction. For example, in a case where the yellow nozzle array Y is positioned on the upstream side in the transport direction and the black nozzle array K is positioned on the downstream side in the transport direction, when the interval between the reference dot array SD formed by the yellow nozzle array Y positioned on the right side in the paper width direction and the reference dot array SD formed by the black nozzle array positioned on the left side is narrow and darkly identified, it is possible to determine that the base plate BP is inclined in the counterclockwise direction, as shown in FIG. 7B.

Print apparatus

In the above-mentioned embodiments, the piezoelectric scheme has been employed in which a voltage is applied on the driving element (piezoelectric element) to expend and shrink the ink chamber and thus the liquid therein is ejected. The thermal scheme may also be employed in which bubbles are generated in the nozzle by using a heating element and the liquid is ejected by the bubbles.

### Serial Type Printer

In the embodiment described above, the line head printer in which the heads are aligned in the paper width direction cross to the transport direction of the medium has been shown by way of example, but the invention is not limited thereto. For example, the inclination or the misalignment of the base plate may be detected on the basis of the above-mentioned test pattern even in a serial type printer which alternately performs an image forming operation for forming an image while the base plate BP with the plural heads mounted thereon moves in the moving direction cross to the transport direction of the medium and a transport operation for transporting the medium.

### Test Pattern

In the above-mentioned pattern P2 (see FIG. 11) and the pattern P3 (see FIG. 14), the first nozzle array L1 and the second nozzle array L2 alternately form the dot arrays, but the invention is not limited thereto. For example, the pattern configured of the plural dot arrays may be formed by alternately using the first nozzle array L1 and the second nozzle array L2.

What is claimed is:

1. A method of adjusting a print apparatus which includes:
a first nozzle array in which nozzles are aligned in a predetermined direction to eject a liquid to a medium;
a second nozzle array in which nozzles are aligned in the predetermined direction to eject a liquid to a medium;
a base plate on which the first nozzle array and the second nozzle array are disposed on positions shifted in a direction cross to the predetermined direction; and
a moving mechanism which moves the base plate and a medium relative to each other in a moving direction, the method comprising:
forming a first pattern by the first nozzle array;
forming a second pattern by the second nozzle array so as to be adjacent to the first pattern in a direction cross to the moving direction; and
adjusting an inclination of the base plate with respect to the moving direction on the basis of an interval between the first pattern and the second pattern in a direction cross to the moving direction.

2. The adjustment method according to claim 1,
wherein the first nozzle array belongs to a first head,
wherein the second nozzle array belongs to a second head,
wherein the first head and the second head are disposed on the base plate such that the first nozzle array and the second nozzle array are shifted in the predetermined direction.

3. The adjustment method according to claim 2,
wherein an inclination direction of the base plate with respect to the moving direction is detected on the basis of an interval between the first pattern and the second pattern in a direction cross to the moving direction.

4. The adjustment method according to claim 2,
wherein an inclination amount of the base plate with respect to the moving direction is detected on the basis of an interval between the first pattern and the second pattern in a direction cross to the moving direction.

5. The adjustment method according to claim 2,
wherein the first nozzle array is positioned to one side in the predetermined direction from the second nozzle array,
wherein the first pattern and the second pattern are each configured such that a plurality of dot arrays disposed in the moving direction are aligned in a direction cross to the moving direction, and
wherein a length of the dot array formed by the nozzle positioned on the end of the other side in the predetermined direction among the nozzles of the first nozzle array forming the first pattern is different from lengths of the dot arrays formed by other nozzles.

6. The adjustment method according to claim 2,
wherein the print apparatus includes a third head having a third nozzle array in which nozzles are aligned in the predetermined direction to eject a liquid to a medium, and is configured such that the first nozzle array and the third nozzle array are aligned in the predetermined direction and the first nozzle array, the second nozzle array, and the third nozzle array are shifted in the predetermined direction in order from one side in the predetermined direction so that the third head is mounted on the base plate, the method further comprising:
forming a third pattern so as to be adjacent to the second pattern in a direction cross to the moving direction by the third nozzle array at the same time as forming the first pattern and the second pattern; and
adjusting an inclination of the base plate with respect to the moving direction by comparing an interval between the first pattern and the second pattern in a direction cross to the moving direction and the interval between the second pattern and the third pattern in a direction cross to the moving direction.

7. The adjustment method according to claim 2,
wherein the first head includes a fourth nozzle array which includes nozzles aligned in the predetermined direction to eject a liquid to a medium, and is aligned in a direction cross to the predetermined direction with respect to the first nozzle array, the method further comprising:
forming a plurality of dot arrays disposed along the moving direction of the first pattern in a direction cross to the moving direction at a predetermined interval by the nozzles of the first nozzle array;
forming a plurality of dot arrays disposed along the moving direction in a direction cross to the moving direction at a predetermined interval by the nozzles of the fourth nozzle array; and
adjusting an inclination of the first head with respect to the moving direction on the basis of a positional relationship in a direction cross to the moving direction between the dot arrays formed by the first nozzle array and the dot arrays formed by the fourth nozzle array.

8. A print apparatus which is adjusted by the adjustment method according to claim 1.
